(19) United States
(12) Patent Application Publication
(10) Pub. No.: US 2007/0097838 A1
(43) Pub. Date: May 3, 2007

(54) Optical disk drive

(75) Inventors: Christinus Antoinetta Paulus Van Liempd, Eindhoven (NL); Antonia Cornelia Van Rens, Eindhoven (NL); Job Franciscus Petrus Van Mil, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/561,996

(22) PCT Filed: Jun. 24, 2004
(86) PCT No.: PCT/IB04/50991

§ 371 Date: Dec. 23, 2005

(51) Int. Cl. G11B 7/00

(52) U.S. Cl. 369/124.03

(57) ABSTRACT

An optical disk drive comprising an electronic unit (PCB) comprising a first circuit (CRT1); an optical pick-up unit (OPU) movably assembled with respect to the electronic unit (PCB) circuit (CRT2) having a plurality of light sensors (PHDS) for receiving reflected light (RFL) from the (DSK), each light sensor having an output for delivering an electrical signal (Ia-Ih); and means for coupling the second circuit (CRT2) to the first circuit (CRT1) for transferring information between the first (CRT1) and second (CRT2) circuits. In a normal operational mode a number of the electrical signals (Ie,Ig;If,Ih) are combined by the second circuit (CRT2), these combined electrical signal (Ie,Ig;If,Ih) and the remaining uncombined electrical signal (Ia-Id) are transferred via the coupling means to the first circuit (CRT1). In a test model all or part of the electrical signals are separately processed by the second (CRT2). The number of electrical connections between the optical pickup unit and the electronic unit may thereby be reduced.

The invention relates in general to an optical disk drive, and more specifically to an optical disk drive comprising an electronic unit comprising a first electronic circuit; an optical pick-up unit that is movably assembled with respect to the electronic unit and comprises light generation means for writing/reading data to/from an optical disk, and comprising a second electronic circuit having a plurality of light sensors for receiving reflected light from the disk which originates from the light generation means, each light sensor having an output for delivering an electrical signal; and coupling means for coupling the second electronic circuit to the first electronic circuit for the transfer of information between the first and second electronic circuits.

The invention also relates to a playback/recording apparatus comprising an optical disk drive.

As is commonly known, an optical storage disk comprises at least one track, either in the form of a continuous spiral or in the form of multiple concentric circles, of storage space where information may be stored in the form of a data pattern. Optical disks may be of the read-only type, where information is recorded during manufacturing, which information can be read by a user. The optical storage disk may also be of a writable type, where information may be stored by a user. For writing information in the storage space of a writable optical storage disk, an optical disk drive comprises, on the one hand, rotating means for receiving and rotating an optical disk, and on the other hand light generation means for generating an optical beam, typically a laser beam, and for scanning the storage track with said laser beam. Since the technology of optical disks in general and the way in which information can be stored in an optical disk are commonly known, it is not necessary here to describe this technology in great detail. For understanding the present invention, it is sufficient to mention that the laser beam is modulated so as to cause a pattern of locations where properties of the disk material have changed, said pattern corresponding to coded information. During recording of an optical disk, a laser driver controls the laser by means of a drive current. This drive current, and consequently the light emitted by the laser, follows a desired pattern determined by the coded information.

The optical disk drive comprises a large amount of mechanics and electronics. The major part of the electronics is placed in the electronic unit in the form of a so-called printed circuit board. The printed circuit board will be further denoted as PCB. The PCB fixed to a housing of the electronic unit is in one way or another. The optical pick-up unit, which will be further denoted as OPU, is movably assembled with respect to the housing and thus also with respect to the PCB. The OPU comprises inter alia the laser, the plurality of light sensors which are usually implemented by light-sensitive photodiodes, a lens system, and part of the electronics of the disk drive. The lens system ensures correct focusing of the laser light on the surface of the disk, and the photodiodes convert the reflected light into electrical signals. The OPU can be moved in horizontal direction by a swing arm or more sledge. Alternative means for moving the OPU may also be applied. Furthermore, the laser and/or lens system can be moved in vertical direction for the purpose of focusing. Owing to the movability of the OPU, the light emitted by the laser can be positioned in order to radiate light onto desired positions of the disk. The use of more than one photodiode renders it possible not only to retrieve an HF-signal from the disk from which the data can be retrieved, but also to measure the deviation and hence to correct the position of the sledge (or other means) and to control the vertical movement of the laser or the lens system. Thus tracking and focusing are also performed with the information (the electrical currents) received from the photodiodes. The tracking is usually denoted as “push-pull” radial tracking. The push-pull tracking is generally known and well described in known literature. Therefore a detailed description of the principles of push-pull is not necessary. In respect of the present invention it suffices to mention that often use is made of the so called three-spot radial tracking push-pull system, which will be further denoted as “3-spot push pull”. The 3-spot push pull is also well known from literature. When using the 3-spot push pull, three spots are generated by the addition of a spatial grating in the light path created by the laser. Three spots are also reflected back to the photodiodes. So usually three segments of photodiodes are used for getting accurate tracking. Normally each segment comprises several photodiodes. Eight separate electrical currents are delivered by the photodiodes in many situations. These currents are transferred to the electronics on the PCB for further processing. Since these currents are quite weak, they are usually first amplified before being transferred to the PCB via the coupling means. In this way these electrical currents are less disturbed by unwanted signals generated somewhere in the electronics which are picked up by the coupling means. Thus by first amplifying the weak electrical signals, a higher signal-to-noise ratio can be achieved. This results in a more reliable control of e.g. the push-pull tracking.

Since the OPU is movable with respect to the PCB, the coupling means cannot be formed by mechanically stiff electrical connections. So special coupling means must be applied, which are not very cheap. There is accordingly a tendency to try and minimize the number of electrical wires within the coupling means.

It is thus an object of the invention to reduce the number of electrical connections between the OPU and the PCB.

To achieve the object of the invention, the optical disk drive as defined in the opening paragraph is characterized in that in a normal operational mode a number of the electrical signals are combined by the second electronic circuit, these combined electrical signals and the remaining uncombined electrical signals being transferred via the coupling means to the first electronic circuit, and that in a test mode all or part of the electrical signals are separately processed by the second electronic circuit.

In the known optical disk drive all electrical signals from the second electronic circuit, which is part of the OPU, are transferred via the coupling means to the first electronic circuit, which is part of the PCB, because in a test mode all these electrical signals are needed separately by a so-called test circuit within the first electronic circuit. The test circuit is only active in the test mode, which is only used during the manufacture of the optical disk drive. In this test mode, a position (including angles) of the photodiodes with respect to the reflected light from a disk is defined (calibration). So this test mode will never be used again during normal operation by the users.

The invention is based on the recognition that not all electrical signals are needed for the retrieval of the HF signal, the tracking, and the focus control since some of them are summed in the first electronic circuit Thus moving the test circuit from the first electronic circuit on the PCB to the second electronic circuit on the OPU then renders it possible to perform the summation already in the second electronic circuit, so that a smaller number of electrical signals have to be transferred via the coupling means to the PCB. The test circuit can be very easily implemented in the second electronic circuit because it is usually implemented in an integrated circuit anyway. Therefore, it does not have the disadvantage of a significant increase in weight of the OPU. An increase in weight could be disadvantageous for the mechanical construction of the OPU and for the power consumption of the OPU. So it is only in the test mode that all electrical signals need separate amplification by the amplifiers. The invention has the additional advantage that in the normal mode, in which some electrical currents from the photodiodes are combined (summed), part of the amplifiers can be switched off. This results in a lower power consumption by the amplifiers. Thus, for example, only 6 out of a total of 8 electrical currents are transferred via the coupling means, and 2 out of a total of 8 amplifiers are switched off in the normal mode.

As defined in claim 2, the coupling means are preferably implemented by a flexible electrical connection device. This is because the OPU must be movable with respect to the PCB.

As defined in claim 3, the flexible electrical connection device may be a flexible printed circuit.

An embodiment of the optical disk drive is characterized in that during operation the light generation means generates a main light spot and a first and a second satellite light spot, in that the plurality of light sensors is subdivided into a main part for receiving light which originates from the main light spot, a first satellite part for receiving light which originates from the first satellite light spot, and a second satellite part for receiving light which originates from the second satellite light spot, and in that the combined electrical signals are combinations of electrical signals corresponding to the first and the second satellite parts of the light sensors.

The 3-spot push pull system mentioned above is used for this. Since some of the electrical currents corresponding to the satellite light spots can be summed in the normal mode, the number of electrical currents to be transferred via the coupling means is reduced. The summation can be accomplished by activating switches which short-circuit an input of an amplifier with an input of another amplifier.

An embodiment of the optical disk drive is characterized in that the second electronic circuit comprises a BUS-system for controlling the gain or gains of at least one of the amplifiers by means of at least one control bit of the BUS-system, and in that additional information can be sent via the BUS-system for switching off or putting into standby part of the amplifiers by the fact that the amplitude of the at least one control bit (which may be a voltage or a current) can be made greater than is necessary for controlling the gain or gains of at least one of the amplifiers. Via the BUS-system, the gain of each amplifier can be set independently of the others. This is advantageous because the first electronic circuit on the PCB may need to process the electrical currents with different gain values. This may be caused, for example, by the fact that the electrical currents corresponding to the satellite light spots are usually much weaker than the electrical currents corresponding to the main light spot. The sending of the additional information via the BUS-system for switching off or putting into standby part of the amplifiers in the abovementioned manner is advantageous because otherwise the number of control bits used for the BUS-system would have to be larger.

An embodiment of the optical disk drive is characterized in that the BUS-system uses a three-level logic. Usually a binary-level logic is applied for a BUS-system. With a three level logic a smaller number of control bits is necessary. In this embodiment the sending of the additional information via the BUS-system for switching off or putting into standby part of the amplifiers, as mentioned in the previous embodiment, can still be accomplished in that the amplitude of the at least one control bit can be made greater than is necessary for controlling the gain or gains of at least one of the amplifiers. Alternatively, as defined in claim 8, the additional information is sent via the BUS-system without making the amplitude of the at least one control bit greater than usual. This is possible because more information can be sent per electrical connection of the BUS-system, with a three-level logic than with a binary-level logic.

An embodiment of the optical disk drive is characterized in that at least one power supply line of the at least one amplifier is also used for sending the additional information by a temporary increase or decrease in the voltage level on the at least one power supply line. If the so-called V_{DD} or V_{SS} power line of an amplifier is used for switching off or putting into standby part of the amplifiers, the number of electrical wires of the BUS-system can be smaller, especially in the situation where a binary-level logic is applied. For example, the lowering of the voltage at the V_{SS} power line of an amplifier can only be temporary because otherwise the corresponding amplifier cannot perform its normal amplifying task when needed. The V_{SS} power line may be, for example, a common V_{SS} power line for all the amplifiers. Alternatively, the same can be accomplished by a V_{DD} power line. In the latter case the voltage on the V_{DD} power line should be temporarily increased. Since the voltage on a power line of an amplifier may only be decreased or increased temporarily, the corresponding amplifiers (the ones needed for the test mode) must be provided with some kind of memory means, e.g. a latch

The invention will be described in more detail with reference to the accompanying drawings, in which:

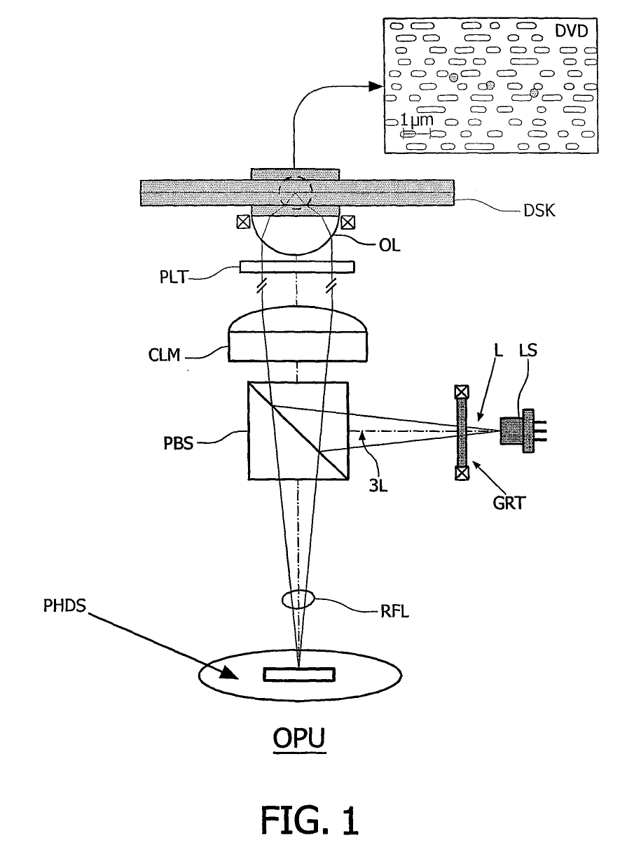

FIG. 1 shows a schematic drawing of an OPU;

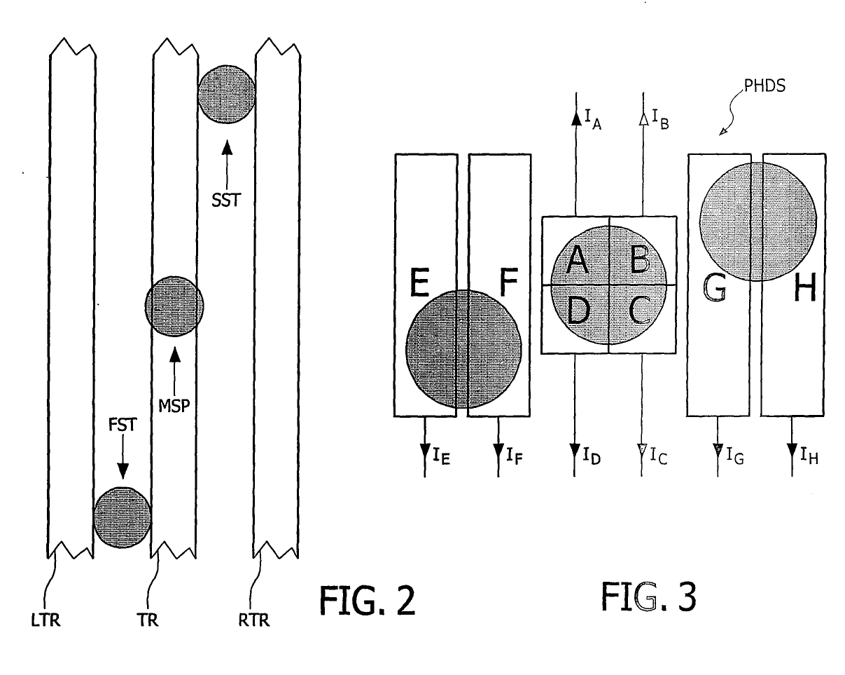

FIG. 2 shows part of tracks radiated by a main spot and two satellites spots;

FIG. 3 shows light-sensitive photodiodes for generating electrical currents in order to retrieve the HF-signal, focus control, and 3-spot push-pull tracking control;

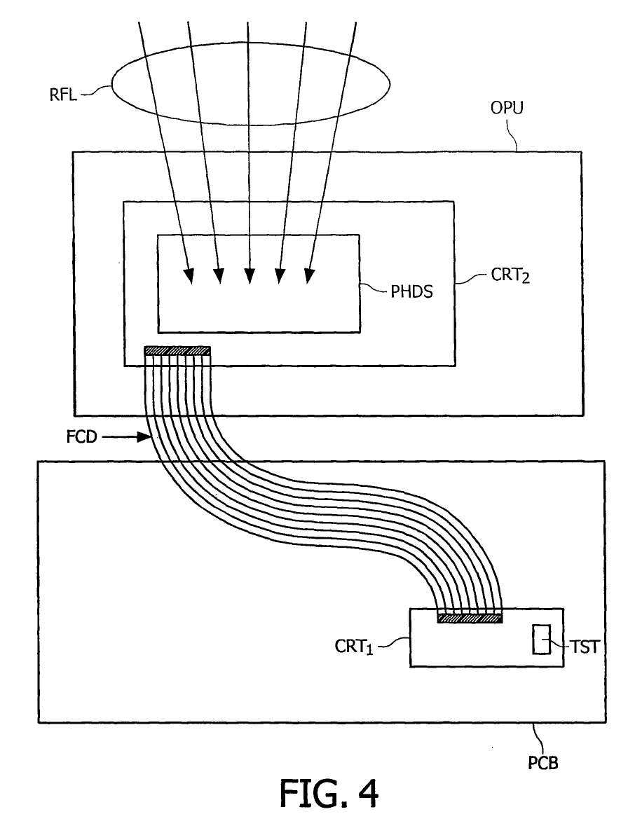

FIG. 4 shows part of an optical disk drive; and

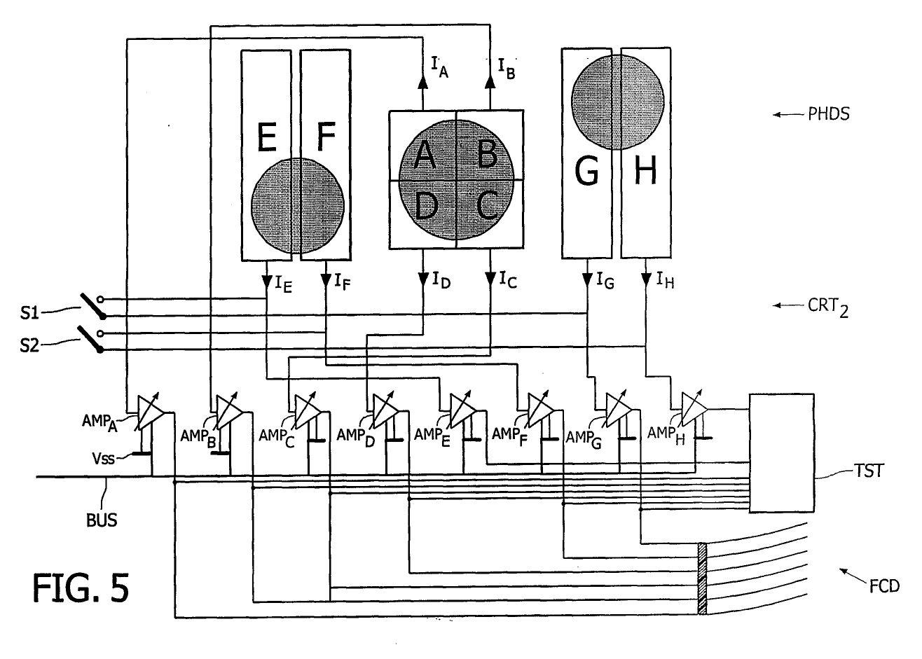

FIG. 5 shows an embodiment of the invention.

Parts or elements having like functions or purposes bear the same reference symbols in these Figures.

FIG. 1 shows an example of a schematic drawing of an OPU. The OPU comprises a laser LS, a spatial grating GRT, a polarized beam splitter PBS, a collimator (lens) CLM, a ¼λ plate PLT, an objective lens OL, and light-sensitive photodiodes PHDS. An optical disk DSK is also shown.

The laser generates a very small light beam L which passes through the grating GRT to form three light beams 3L. The three light beams 3L are necessary in the situation where a so-called 3-spot push-pull tracking control is desired. (Otherwise the grating GRT can be left out.) The three light beams 3L are mirrored towards the collimator CLM by the polarized beam splitter PBS. The diverging light beams issuing from the collimator CLM are changed into parallel (that is to say non-diverging and non-converging) light beams. The parallel light beams pass through the ¼λ plate PLT, which shift the polarization of the light beams by approximately 90 degrees. The objective lens OL converges the light beams onto the desired positions of the optical disk DSK which is, for example, a DVD. (Depending on the design, it is sometimes possible to leave out the collimator CLM by choosing a higher diopter value for the objective lens OL.)

Light reflected from the disk DSK, which is now modulated by the information on the disk DSK, passes through the ¼λ plate PLT for shifting the polarization of the light by approximately 90 degrees. It then passes through the collimator CLM. Since the polarization of the reflected light is now opposed (shifted by 180 degrees) to that of the “incoming” light beams from the laser LS, it is not mirrored back towards the laser LS by the polarized beam splitter PBS but passes through the polarized beam splitter PBS. Thus reflected light indicated by RFL, is focused on the light-sensitive photodiodes PHDS. The photodiodes PHDS respond to this light by generating electrical currents which comprise the data read from the disk DSK, which data can be retrieved after demodulation of the HF-signal(s) delivered by the photodiodes PHDS, said signal(s) comparing information needed for focus control and for (3-spot) push-pull tracking control.

FIG. 2 shows part of tracks irradiated by a main light spot and two satellite light spots. The main light spot MSP is focused on track TR, while a first satellite light spot FST is incident between a left track LTR and the track TR and a second satellite light spot SST is incident between the track TR and a right track RTR. In the situation shown, there is an ideal push-pull tracking, and the reflected light RFL (see FIG. 1) hits the photodiodes PHDS in the way indicated in FIG. 3. (This is under the assumption that in the manufacturing process the position/angles of the photodiodes are calibrated during a so-called test mode phase.) Temporarily the spots MSP, FST, and SST may be shifte, for example, towards the left. Then, however, a main part A-B of the photodiodes PHDS which receives light corresponding to the main light spot MSP will also shift, and consequently the electrical signals I_{A}-I_{B} will change. The same holds for the first E,F and second G,H satellite parts of the photodiodes PHDS, which receive light corresponding to the first FST and the second SST satellite light spots, respectively. In response to the changes in the electrical signals I_{A}-I_{H}, a push-pull tracking control (also often called servo control) changes the horizontal position of the laser beams focused on the disk DSK, for example by means of a so-called sledge (not shown in FIG. 1) on which the OPU is mounted. Focus control and the retrieving of the code information can also be derived from the electrical currents I_{A}-I_{H}. Since the retrieving of the data, the focus control, and the push-pull control are well known techniques, a more detailed explanation of these techniques is not necessary.

FIG. 4 shows part of an optical disk drive. The optical disk drive comprises inter alia a PCB which comprises the major part of the electronics. Part of these electronics is indicated as a first electronic circuit CRT₁. The optical disk drive further comprises an OPU which comprises several mechanical components (not indicated in FIG. 4) and some electronics indicated as a second electronic circuit CRT₂. The second electronic circuit CRT₂ comprises the photodiodes PHDS (see also FIG. 3) for receiving the reflected light RFL (see also FIG. 1). The photodiodes PHDS deliver the electrical currents (see I_{A}-I_{H} in FIG. 3). In the known disk drives, all these electrical currents are transferred via a flexible electrical connection device FCD to the first electronic circuit CRT₁. The first electronic circuit CRT₁ processes the electrical currents. Some currents are summed. In fact, this summation could already have been accomplished in the second electronic circuit CRT₂ so that a smaller number of electrical wires are needed in the flexible electrical connection device FCD. Up to now this has not been done because all electrical currents are separately needed in a test mode which is performed by a test circuit TST within the first electronic circuit

In the inventive embodiment as shown in FIG. 5 the test circuit TST is part of the second electronic circuit CRT₂ instead of the first electronic circuit CRT₁ (and thus part of the OPU instead of the PCB). The test circuit TST is only active in the test mode, which is only used during the manufacture of the optical disk drive. In this test mode a position (including angles) of the photodiodes PHDS with respect to the reflected light from a disk DSK, is defined (calibration). The switches S₁ and S₂ are open (as indicated in FIG. 5) in the test mode. As a consequence all the electrical currents I_{A}-I_{H} are separately amplified by the amplifiers AMP_{A}-AMP_{H}, and all output currents from the amplifiers AMP_{A}-AMP_{H} are separately coupled to the test circuit TST.

In the normal (user) mode, the test circuit TST is always inactive and the switches S₁ and S₂ are closed. Furthermore, the amplifiers AMP_{E} and AMP_{H} are also made inactive. This can be controlled via the bus system BUS. The closure of the switch S₁ adds the electrical current I_{E}, which can no longer be amplified by the amplifier AMP_{E}, to the electrical current I_{G}, so that the sum of these two currents is amplified by the amplifier AMP_{G}. The closure of the switch S₂ adds the electrical current I_{H}, which can no longer be amplified by the amplifier AMP_{H}, to the electrical current I_{F}, so that the sum of these two currents is amplified by the amplifier AMP_{F}. The outputs of the amplifiers, except for the amplifiers AMP_{E} and AMP_{H}, are coupled to the flexible electrical connection device FCD. So, in this example, only six electrical currents are transferred via the flexible electrical connection device FCD instead of eight in the known optical disc drives.

The bus system BUS delivers control bits for setting the gains of the amplifiers AMP_{A}-AMP_{H}. These gains can be set individually. The amplifiers AMP_{E} and AMP_{H} can be switched off in the normal mode via an extra control bit This saves power. Instead of using the extra control bit it is also possible to temporarily increase/decrease the voltage/current of a control bit (used for setting a gain) to above/below a normal voltage/current value so as to indicate that the amplifiers AMP_{E} and AMP_{H} should be switched off. Instead of using a control bit it is also possible, for example, to temporarily decrease the voltage level on the V_{SS} power line of the opamps AMP_{A}-AMP_{H}.

Alternatively, the bus system BUS may use three-level logic control bits so that more information per control bit is available. Then both the gain setting signals and the switching-off signals for the opamps AMP_{A}-AMP_{H} can be delivered via the BUS-system without any increase in the number of control bits.

1. An optical disk drive comprising an electronic unit (PCB) comprising a first electronic circuit (CRT₁); an optical pick-up unit (OPU) that is movably assembled with respect to the electronic unit (PCB) and comprises light generation means (LS) for writing/reading data to/from an optical disk (DSK), and comprising a second electronic circuit (CRT₂) having a plurality of light sensors (PHDS) for receiving reflected light (RFL) from the disk (DSK) which originates from the light generation means (LS), each light sensor having an output for delivering an electrical signal (I_{A}-I_{H}); and coupling means for coupling the second electronic circuit (CRT₂) to the first electronic circuit (CRT₁) for the transfer of information between the first (CRT₁) and second (CRT₂) electronic circuits, characterized in that in a normal operational mode a number of the electrical signals (I_{E},I_{G}; I_{F},I_{H}) are combined by the second electronic circuit (CRT₂), these combined electrical signals (I_{E},I_{G}; I_{F},I_{H}) and the remaining uncombined electrical signals (I_{A}-I_{D}) being transferred via the coupling means to the first electronic circuit (CRT₁), and that in a test mode all or part of the electrical signals are separately processed by the second electronic circuit (CRT₂).

2. An optical disk drive according to claim 1, characterized in that the second electronic circuit (CRT₂) comprises a plurality of amplifiers (AMP_{A}-AMP_{H}) each having an input separately coupled to the outputs of the light sensors in the test mode and each having an output, in that a number of the outputs of the amplifiers, which number equals the number of the combined and the remaining uncombined electrical signals in the normal operational mode, is separately coupled to the coupling means; and in that a number of the inputs of the amplifiers, which number equals the number of the combined electrical signals, is separately coupled to other inputs of the amplifiers in the normal operational mode.

3. An optical disk drive according to claim 1, characterized in that the coupling means are implemented by a flexible electrical connection device (FCD).

4. An optical disk drive according to claim 3, characterized in that the flexible electrical connection device (FCD) is a flexible printed circuit.

5. An optical disk drive according to claim 3, characterized in that during operation the light generation means (LS) generates a main light spot (MSP) and a first (FST) and a second (SST) satellite light spot, in that the plurality of light sensors (PHDS) is subdivided into a main part for receiving light which originates from the main light spot, a first satellite part for receiving light which originates from the first satellite light spot, and a second satellite part for receiving light which originates from the second satellite light spot, and in that the combined electrical signals (I_{E},I_{G}; I_{F},I_{H}) are combinations of electrical signals corresponding to the first and the second satellite parts of the light sensors.

6. An optical disk drive according to claim 5, characterized in that the main part comprises four sections (A, B, C, D) for delivering four of the electrical signals, further to be denoted the four main electrical signals (I_{A}, I_{B}, I_{C}, I_{D}), the first satellite part comprises two sections (E, F) for delivering two of the electrical signals not being the four main electrical signals (I_{A}, I_{B}, I_{C}, I_{D}), further to be denoted the two first satellite part electrical signals (I_{E}, I_{F}), and the second satellite part comprises two sections (G, H) for delivering two of the electrical signals not being the four main electrical signals (I_{A}, I_{B}, I_{C}, I_{D}) or the two first satellite part electrical signals (I_{E}, I_{F}), further to be denoted the two second satellite part electrical signals (I_{G}, I_{H}), and in that in the normal operational mode at least one of the two first satellite part electrical signals (I_{E}, I_{F}) is combined with at least one of the two second satellite part electrical signals (I_{G}, I_{H}).

7. An optical disk drive according to claim 2, characterized in that the second electronic circuit (CRT₂) comprises a BUS-system (BUS) for controlling the gain or gains of at least one of the amplifiers (AMP_{A}-AMP_{H}) by means of at least one control bit of the BUS-system (BUS), and in that additional information can be sent via the BUS-system (BUS) for switching off or putting into standby part of the amplifiers by the fact that the amplitude of the at least one control bit can be made greater than is necessary for controlling the gain or gains of at least one of the amplifiers.

8. An optical disk drive according to claim 7, characterized in that the BUS-system (BUS) uses a three-level logic.

9. An optical disk drive according to claim 2, characterized in that the second electronic circuit (CRT₂) comprises a three-level logic BUS-system (BUS) for controlling the gain or gains of at least one of the amplifiers (AMP_{A}-AMP_{D}) by means of at least one control bit of the BUS-system (BUS) and for sending additional information via the BUS-system (BUS) for switching off or putting into standby part of the amplifiers.

10. An optical disk drive according to claim 7, characterized in that at least one power supply line (V_{SS}) of the at least one amplifier (AMP_{A}-AMP_{D}) is also used for sending the additional information by temporarily increasing or decreasing the voltage level on the at least one power supply line (V_{SS}).

11. A playback/recording apparatus comprising an optical disk drive as defined in claim 7.
